(19) United States
(12) Patent Application Publication
(10) Pub. No.: US 2014/0091225 A1
(43) Pub. Date: Apr. 3, 2014

(54) RADIATION IMAGING APPARATUS, RADIATION IMAGING SYSTEM, AND RADIATION IMAGING APPARATUS MANUFACTURING METHOD

(71) Applicant: Canon Kabushiki Kaisha, Tokyo (JP)

(72) Inventors: Yoshito Sasaki, Kumagaya-shi (JP); Satoshi Okada, Tokyo (JP); Yohei Ishida, Honjo-shi (JP); Akiya Nakayama, Kawasaki-shi (JP)

(73) Assignee: Canon Kabushiki Kaisha, Tokyo (JP)

(21) Appl. No.: 14/034,982

(22) Filed: Sep. 24, 2013

(30) Foreign Application Priority Data
Oct. 2, 2012 (JP) 2012-220716

(51) Int. Cl. G01T 1/20

(52) U.S. Cl. CPC G01T 1/2006
USPC 250/366

(57) ABSTRACT

The present invention provides a radiation imaging apparatus including a sensor substrate on which photoelectric conversion elements are arranged, a scintillator base on which a scintillator layer for converting radiation into light with a wavelength detectable by the photoelectric conversion elements is arranged, and which is adhered to the sensor substrate so that the scintillator layer is arranged between the sensor substrate and the scintillator base, and a sealing member configured to fix an edge portion of the scintillator base and the sensor substrate, and spaced apart from the scintillator layer, wherein the scintillator base includes a bent portion for reducing a stress that acts on the sealing member in a region between an outer edge of a region in which the scintillator layer is arranged and the edge portion fixed by the sealing member.

### BACKGROUND OF THE INVENTION

1. Field of the Invention

The present invention relates to a radiation imaging apparatus, a radiation imaging system, and a radiation imaging apparatus manufacturing method.

2. Description of the Related Art

In recent years, radiation imaging apparatuses in which a scintillator (scintillator substrate) for converting radiation such as X-rays into light with a wavelength detectable by a photoelectric conversion element is stacked (arranged) on a sensor panel on which a plurality of photoelectric conversion elements are formed have been commercialized.

Japanese Patent Laid-Open No. 2004-061116 proposes a technique of using, when a scintillator substrate and a sensor panel are adhered, an acrylic resin as a resin (sealant) for sealing their periphery in such radiation imaging apparatus.

If cesium iodide (CsI) having strong hygroscopicity is used as a scintillator, however, the sealant used for the conventional radiation imaging apparatus is not sufficient in terms of the moisture resistance (humidity resistance) of the scintillator.

To solve this problem, high moisture resistance may be obtained by using a resin having a high elastic modulus as a sealant. However, if a resin having a high elastic modulus is used to seal a sensor panel and a substrate such as a scintillator substrate, which have different thermal expansion coefficients, a thermal shock may cause the failure of the sealant. This is because a stress acts on the sealant due to a difference in thermal expansion between the scintillator substrate and the sensor panel.

### SUMMARY OF THE INVENTION

The present invention provides a radiation imaging apparatus which is advantageous in improving the moisture resistance of a scintillator layer and the strength of a sealing member.

According to one aspect of the present invention, there is provided a radiation imaging apparatus including a sensor substrate on which photoelectric conversion elements are arranged, a scintillator base on which a scintillator layer for converting radiation into light with a wavelength detectable by the photoelectric conversion elements is arranged, and which is adhered to the sensor substrate so that the scintillator layer is arranged between the sensor substrate and the scintillator base, and a sealing member configured to fix an edge portion of the scintillator base and the sensor substrate, and spaced apart from the scintillator layer, wherein the scintillator base includes a bent portion for reducing a stress that acts on the sealing member in a region between an outer edge of a region in which the scintillator layer is arranged and the edge portion fixed by the sealing member.

Further features of the present invention will become apparent from the following description of exemplary embodiments with reference to the attached drawings.

### BRIEF DESCRIPTION OF THE DRAWINGS

FIGS. 1A and 1B are views showing the arrangement of a radiation imaging apparatus according to an aspect of the present invention.

FIG. 2 is a view showing another arrangement of the sensor panel of the radiation imaging apparatus shown in FIGS. 1A and 1B.

FIG. 3 is a view showing the arrangement of a bent portion formed on the scintillator base of the radiation imaging apparatus shown in FIGS. 1A and 1B.

FIGS. 4A and 4B are views showing the arrangement of the bent portion formed on the scintillator base of the radiation imaging apparatus shown in FIGS. 1A and 1B.

FIGS. 5A and 5B are views showing the arrangement of the bent portion formed on the scintillator base of the radiation imaging apparatus shown in FIGS. 1A and 1B.

FIG. 6 is a schematic cross-sectional view showing the arrangement of a radiation imaging apparatus according to a comparative example.

FIGS. 7A to 7H are views for explaining a method of manufacturing the radiation imaging apparatus according to the comparative example.

FIGS. 8A to 8J are views for explaining a method of manufacturing the radiation imaging apparatus shown in FIGS. 1A and 1B.

FIGS. 9A to 9F are views for explaining a method of manufacturing the radiation imaging apparatus shown in FIGS. 1A and 1B.

FIGS. 10A to 10E are views for explaining a method of manufacturing the radiation imaging apparatus shown in FIGS. 1A and 1B.

FIG. 11 is a view for explaining a case in which the radiation imaging apparatus is applied to a system.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

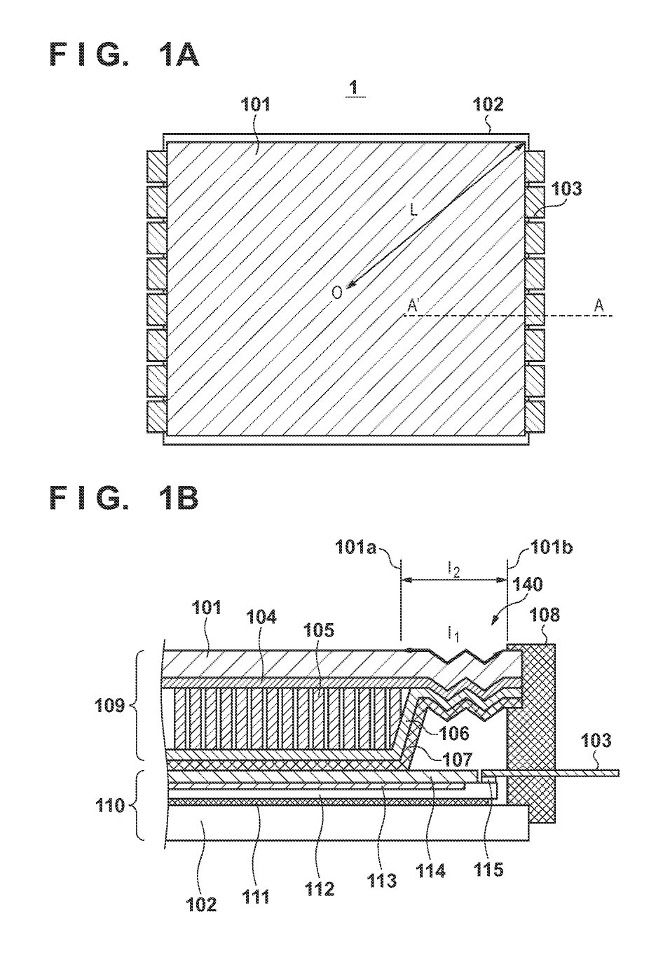

FIG. 1A is a schematic plan view showing the arrangement of a radiation imaging apparatus 1 according to an aspect of the present invention. FIG. 1B is a cross-sectional view taken along a line A′-A of the radiation imaging apparatus 1 shown in FIG. 1A. The radiation imaging apparatus 1 includes photoelectric conversion elements and a scintillator layer for converting radiation into light such as visible light with a wavelength detectable by the photoelectric conversion elements. The radiation includes not only X-rays but also electromagnetic waves such as α-rays, β-rays, and γ-rays. As shown in FIGS. 1A and 1B, the radiation imaging apparatus 1 includes a scintillator panel (fluorescent screen) 109 and a sensor panel (optical sensor or photoelectric conversion panel) 110, which are adhered by an adhesion layer 107.

The sensor panel 110 will be explained first. The sensor panel 110 includes a sensor base 102, an adhesion layer 111, a sensor substrate 112, a photoelectric conversion portion 113, a sensor protection layer 114, and wiring leads 115.

The sensor substrate 112 is an insulating substrate which is adhered to the sensor base 102 by the adhesion layer 111 and is made of, for example, glass. The photoelectric conversion portion 113 in which photoelectric conversion elements and switching elements (not shown) such as TFTs are two-dimensionally arrayed is arranged in the sensor substrate 112. The wiring leads 115 serve as bonding pad portions used to electrically connect external wiring lines 103 of an external flexible substrate or the like to the sensor substrate 112. The sensor protection layer 114 is arranged to cover the photoelectric conversion portion 113, and has a function of protecting the photoelectric conversion portion 113. The adhesion layer 111 adheres the sensor substrate 112 to the sensor base 102.

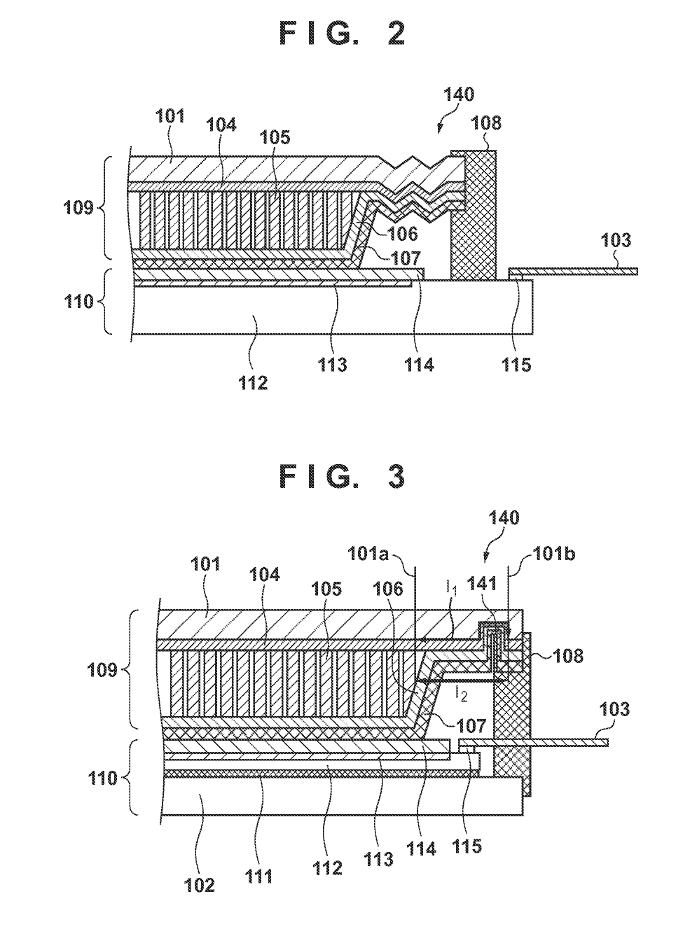

The sensor panel 110 may be formed by tiling the sensor substrate 112 as shown in FIG. 1B or by arranging the photoelectric conversion portion 113 in the insulating sensor substrate 112 made of, for example, glass, as shown in FIG. 2.

The sensor protection layer 114 may be made of SiN, TiO₂, LiF, Al₂O₃, MgO, or the like. The sensor protection layer 114 may be made of a polyphenylene sulfide resin, fluororesin, polyether ether ketone resin, liquid crystal polymer, polyether nitrile resin, polysulfone resin, polyether sulfone resin, polyarylate resin, or the like. Alternatively, the sensor protection layer 114 may be made of a polyamide-imide resin, polyether-imide resin, polyimide resin, epoxy resin, silicone resin, or the like. Note that if the radiation imaging apparatus 1 is irradiated with radiation, light converted by the scintillator layer 105 passes through the sensor protection layer 114. Therefore, the sensor protection layer 114 may be made of a material having high transmittance with respect to the wavelength of the light converted by the scintillator layer 105.

The scintillator panel 109 will be described next. The scintillator panel 109 includes a scintillator base 101, a base protection layer 104, a scintillator layer 105, and a scintillator protection layer 106.

The scintillator base 101 is made of a material which has high transmittance with respect to X-rays, readily, plastically deforms, and is easy to process. The scintillator base 101 is made of, for example, at least one of beryllium (Be), magnesium (Mg), aluminum (Al), a composite material such as a clad plate thereof, or an alloy containing aluminum or magnesium as a principal component. The scintillator layer 105 is arranged on the scintillator base 101 via the base protection layer 104. Furthermore, a reflection layer for effectively using the light converted by the scintillator layer 105 may be arranged on the scintillator base 101. Such reflection layer is made of a high reflectance material such as silver (Ag) or aluminum (Al). Note that if the scintillator base 101 is made of aluminum, the scintillator base 101 also functions as a reflection layer and thus no reflection layer needs to be arranged.

The scintillator layer 105 has an area smaller than that of the scintillator base 101. The scintillator layer 105 is made of a columnar crystal scintillator represented by cesium iodide doped with a trace amount of thallium (Tl) (CsI:Tl) or a particulate scintillator represented by gadolinium sulfate doped with a trace amount of terbium (Tb) (GOS:Tb). In this embodiment, the scintillator layer 105 is made of a columnar crystal scintillator containing cesium iodide as a principal component.

The scintillator protection layer 106 is arranged on the scintillator layer 105. The scintillator protection layer 106 has a function of protecting the scintillator layer 105 from moisture degradation (has moisture resistance or humidity resistance). Especially if the scintillator layer 105 is made of a columnar crystal scintillator such as CsI:Tl, the characteristics of the scintillator layer 105 suffers due to moisture degradation and thus the scintillator protection layer 106 is needed. As a material for the scintillator protection layer 106, for example, a general organic material such as a silicone resin, acrylic resin, or epoxy resin, or a hot-melt resin such as a polyester-based resin, polyolefin-based resin, or polyamide-based resin can be used. Note that it may be to use, as a material for the scintillator protection layer 106, a resin having low moisture permeability such as a poly-para-xylylene organic layer formed by CVD or a hot-melt resin represented by a polyolefin-based resin.

The scintillator panel 109 and sensor panel 110 are adhered by the adhesion layer 107 so that the scintillator protection layer 106 and sensor protection layer 114 oppose each other, and are sealed by a sealing member 108. The sealing member 108 is spaced apart from the scintillator layer 105, and fixes the edge portion of the scintillator base 101 and the sensor base 102 (see FIG. 1B) or sensor substrate 112 (see FIG. 2). To improve the moisture resistance of the scintillator panel 109, it may be to use, as a material for the sealing member 108, a resin having low moisture permeability, specifically, an epoxy resin, similarly to the scintillator protection layer 106. A silicone- or acrylic-based resin has an elastic force smaller than that of an epoxy resin, and can thus flexibly cope with a stress due to a difference in thermal expansion between the scintillator panel 109 and the sensor panel 110, but is inferior in moisture resistance. The sealing member 108 may be made of a resin having a high elastic modulus (for example, 1 Gpa or higher) or a thermosetting resin.

The scintillator protection layer 106 provides a moisture-proof protection function of preventing moisture from externally entering the scintillator layer 105 and an impact protection function of preventing damage to the scintillator layer 105 by impact. If the scintillator layer 105 is made of a scintillator having a columnar crystal structure, the scintillator protection layer 106 has a thickness of 10 to 200 μm. If the thickness of the scintillator protection layer 106 is 10 μm or smaller, it may be impossible to completely cover the uneven surface of the scintillator layer 105 or a large convex portion generated by abnormal growth in deposition, thereby lowering the moisture-proof protection function. On the other hand, if the thickness of the scintillator protection layer 106 is larger than 200 μm, the scattering of light converted by the scintillator layer 105 or reflected by the reflection layer increases in the scintillator protection layer 106. Therefore, the MTF (Modulation Transfer Function) and resolution of an image obtained in the radiation imaging apparatus 1 may decrease.

In this embodiment, a bent portion 140 is formed in the scintillator base 101 to reduce a stress that acts on the sealing member 108 due to a difference in thermal expansion between the scintillator panel 109 and the sensor panel 110. More specifically, the scintillator base 101 includes the bent portion 140 in a region between an outer edge 101a of a region where the scintillator layer 105 is arranged and an edge portion 101b fixed by the sealing member 108, as shown in FIG. 1B. Note that the edge portion 101b of the scintillator base 101 is a portion of the scintillator base 101 outside the bent portion 140.

A condition to be satisfied by the bent portion 140 will now be described. Let l₁ be the distance, along the surface of the scintillator base 101, between the edge portion 101b and the outer edge 101a of the region of the scintillator base 101 where the scintillator layer 105 is arranged, and l₂ be the linear distance between the edge portion 101b and the outer edge 101a of the region of the scintillator base 101 where the scintillator layer 105 is arranged. In order for the bent portion 140 to effectively reduce a stress that acts on the sealing member 108, l₁ need only be larger than l₂ as much as possible, and the length of the bent portion 140 need only be larger than a difference between a contraction amount due to the heat of the scintillator panel 109 and that due to the heat of the sensor panel 110. The bent portion 140, therefore, need only satisfy

l₁−l₂≧(α−β)×L×(t₁−t₂) (1)

where L represents the longest distance from a center O of the scintillator base 101 to its edge portion, α represents the thermal expansion coefficient of the scintillator base 101, β represents the thermal expansion coefficient of the sensor substrate 112, t₁ represents the curing temperature of the sealing member 108, and t₂ represents the lowest temperature in an environment in which the radiation imaging apparatus 1 is used.

The bent portion 140 may have various shapes. For example, the bent portion 140 has a zigzag shape (bellows shape) in a cross section perpendicular to the surface of the scintillator base 101, as shown in FIGS. 1B and 2. The zigzag-shaped bent portion 140 may be formed at any position in the region between the outer edge 101a of the region where the scintillator layer 105 is arranged and the edge portion 101b fixed by the sealing member 108. By forming part of the scintillator base 101 into a zigzag shape, it is possible to reduce a stress that acts on the sealing member 108 due to a difference in thermal expansion between the scintillator panel 109 and the sensor panel 110.

As a method of forming a zigzag shape as the bent portion 140 in the scintillator base 101, it is preferable to press the scintillator base 101 using a die on which an uneven surface corresponding to the zigzag shape of the bent portion 140 is formed. It is possible to perform a process of forming the bent portion 140 in the scintillator base 101 by a press using the die before or after forming the base protection layer 104, after forming the scintillator protection layer 106, or after forming the adhesion layer 107. Note that it is preferable to perform the process of forming the bent portion 140 in the scintillator base 101 after forming the base protection layer 104.

The bent portion 140 may include a concave portion 141 concave toward the sensor substrate in a cross section perpendicular to the surface of the scintillator base 101, as shown in FIG. 3. The concave portion 141 of the bent portion 140 needs to be formed outside the outer edge 101a of the region where the scintillator layer 105 is arranged. Furthermore, the sealing member 108 needs to be formed outside the concave portion 141 (the bottom surface thereof) of the bent portion 140. By forming the concave portion 141 in part of the scintillator base 101, it is possible to reduce a stress that acts on the sealing member 108 due to a difference in thermal expansion between the scintillator panel 109 and the sensor panel 110.

As a method of forming the concave portion 141 in the scintillator base 101, as described above, it is preferable to press the scintillator base 101 using a die on which an uneven surface corresponding to the concave portion 141 is formed. Alternatively, the concave portion 141 may be formed by laser processing or cutting. As described above, it is preferable to perform the process of forming the concave portion 141 in the scintillator base 101 after forming the base protection layer 104.

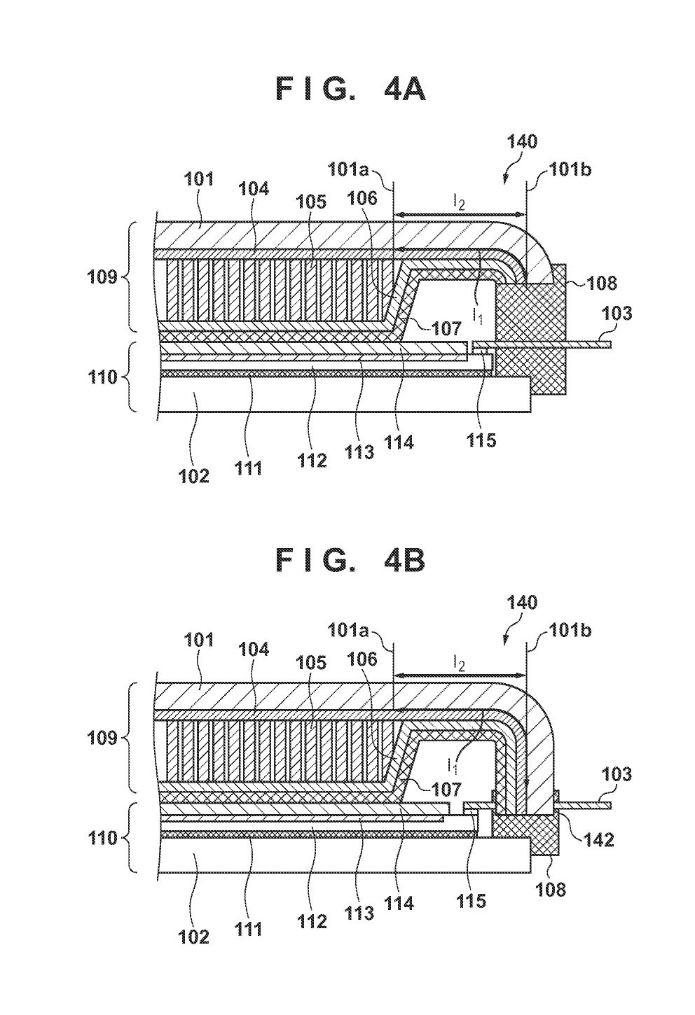

Furthermore, as shown in FIGS. 4A and 4B, the bent portion 140 may have a curved surface shape which curves toward the sensor substrate in a cross section perpendicular to the surface of the scintillator base 101. The bent portion 140 having a curved surface shape needs to be formed outside the outer edge 101a of the region where the scintillator layer 105 is arranged. It is also necessary to form the sealing member 108 outside the start position from which the curved surface shape of the bent portion 140 is formed. By forming part of the scintillator base 101 to have a curved surface shape, it is possible to reduce a stress that acts on the sealing member 108 due to a difference in thermal expansion between the scintillator panel 109 and the sensor panel 110.

As a method of forming a curved surface shape as the bent portion 140 in the scintillator base 101, as described above, it is preferable to press the scintillator base 101 using a die on which an uneven surface corresponding to the curved surface shape of the bent portion 140 is formed. As described above, it is preferable to perform the process of forming the bent portion 140 having a curved surface shape in the scintillator base 101 after forming the base protection layer 104.

If the bent portion 140 has a curved surface shape, it is possible to form, in the bent portion 140, a supporting portion 142 for supporting the external wiring line 103 of the flexible substrate, as shown in FIG. 4B. The supporting portion 142 is formed by, for example, a hole (cavity) in which the external wiring line 103 can be inserted. Examples of a method of forming a hole in the scintillator base 101 (bent portion 140) are punching and cutting using a press machine. However, laser processing is preferably used. It is necessary to form, in the bent portion 140, the sealing member 108 to fill the hole formed as the supporting portion 142 outside the start position from which the curved surface shape of the bent portion 140 is formed, as described above.

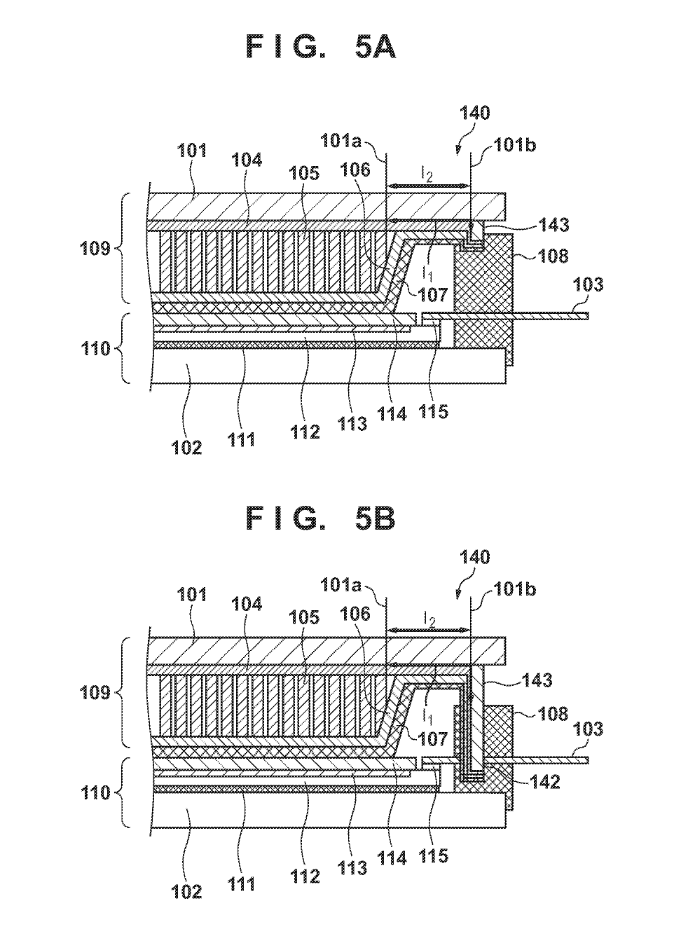

Furthermore, as shown in FIGS. 5A and 5B, the bent portion 140 may include a convex portion 143 convex toward the sensor substrate in a cross section perpendicular to the surface of the scintillator base 101. It is necessary to form the convex portion 143 of the bent portion 140 outside the outer edge 101a of the region where the scintillator layer 105 is arranged. It is also necessary to form the sealing member 108 to contact the convex portion 143 of the bent portion 140 but not to contact the scintillator base 101. The base protection layer 104, scintillator protection layer 106, and adhesion layer 107 need not cover the convex portion 143 but may cover the convex portion 143. By forming the convex portion 143 in part of the scintillator base 101, it is possible to reduce a stress that acts on the sealing member 108 due to a difference in thermal expansion between the scintillator panel 109 and the sensor panel 110.

As a method of forming the convex portion 143 in the scintillator base 101, as described above, it is preferable to press the scintillator base 101 using a die on which an uneven surface corresponding to the convex portion 143 is formed. It is also possible to form the convex portion 143 by welding, to the scintillator base 101, a frame body made of the same material as that of the scintillator base 101.

The supporting portion 142 for supporting the external wiring line 103 of the flexible substrate can be formed in the convex portion 143 of the bent portion 140, as shown in FIG. 5B. The sealing member 108 is formed to fill the hole formed as the supporting portion 142 in the convex portion 143.

The practical characteristics of the radiation imaging apparatus 1 according to the present invention will be described below by comparing with radiation imaging apparatuses according to Comparative Examples 1 and 2.

### Comparative Example 1

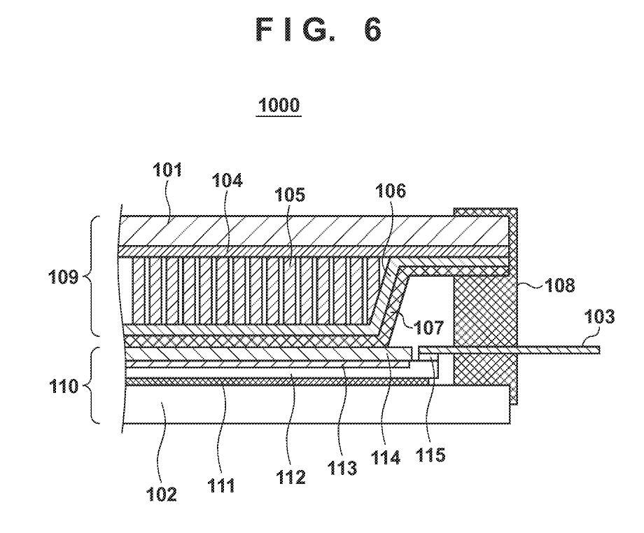

FIG. 6 is a schematic cross-sectional view showing the arrangement of a radiation imaging apparatus 1000 according to Comparative Example 1 or 2 to be described below. Unlike the radiation imaging apparatus 1, in the radiation imaging apparatus 1000, a bent portion 140 for reducing a stress that acts on a sealing member 108 due to a difference in thermal expansion between a scintillator panel 109 and a sensor panel 110 is not formed in a scintillator base 101, as shown in FIG. 6.

A method of manufacturing the radiation imaging apparatus 1000 according to Comparative Example 1 or 2 will be described with reference to FIGS. 7A to 7H. As shown in FIG. 7A, a scintillator base 101 made of aluminum is prepared first. As shown in FIG. 7B, a polyimide resin is applied to the scintillator base 101, and is cured, thereby forming a base protection layer 104.

Next, as shown in FIG. 7C, a scintillator layer 105 having a columnar crystal structure is formed on the base protection layer 104 formed on the scintillator base 101. If the scintillator layer 105 is made of CsI:Tl, the scintillator layer 105 is formed by co-depositing CsI (cesium iodide) and TlI (thallium iodide). More specifically, a resistance heating boat is filled with the material of the scintillator layer 105 as vapor deposition materials, and the scintillator base 101 on which the base protection layer 104 is formed is set on a rotatable holder which is arranged within a vapor deposition apparatus. The interior of the vapor deposition apparatus is evacuated, argon (Ar) gas is introduced, the degree of vacuum is adjusted, and then the scintillator layer 105 is deposited on the base protection layer 104.

As shown in FIG. 7D, a scintillator protection layer 106 made of polyethylene terephthalate (PET) is formed on the scintillator layer 105 by thermocompression bonding so as to cover the scintillator layer 105. Note that a PET film having a thickness of 15 μm is used as the scintillator protection layer 106.

With the processes shown in FIGS. 7A to 7D, a scintillator panel 109 including the scintillator layer 105 which converts radiation into light with a wavelength detectable by photoelectric conversion elements is formed.

As shown in FIGS. 7E, 7F, and 7G, the scintillator panel 109 is adhered to the sensor panel 110 via an adhesion layer 107 made of an acrylic-based resin. The sensor panel 110 is formed by adhering a sensor substrate 112, in which a photoelectric conversion portion 113 and a sensor protection layer 114 are formed, to a sensor base 102 via an adhesion layer 111. Bubbles generated when adhering the scintillator panel 109 and sensor panel 110 are removed by performing defoaming processing such as the application of pressure or heat.

Next, as shown in FIG. 7H, a sealing member 108 made of a silicone-based resin having a low elastic modulus is formed in the edge portion of the scintillator base 101 and that of the sensor base 102, and external wiring lines 103 undergo thermocompression bonding to wiring leads 115 on the sensor substrate 112.

A humidity tolerance test was performed for the thus manufactured radiation imaging apparatus 1000. More specifically, after the radiation imaging apparatus 1000 was left to stand for 240 hours in an environment of a temperature of 55° C. and a humidity of 95%, the MTF (Modulation Transfer Function) of the radiation imaging apparatus 1000 was measured, thereby evaluating the MTF before and after the humidity tolerance test.

An MTF evaluation method was as follows. First, the radiation imaging apparatus 1000 was set on an evaluation apparatus, and an Al filter having a thickness of 20 mm for soft X-ray removal was set between an X-ray source and the apparatus. The distance between the radiation imaging apparatus 1000 and the X-ray source was adjusted to 130 cm, and the radiation imaging apparatus 1000 was connected to an electric driving system. In this state, an MTF chart was mounted on the radiation imaging apparatus 1000 at a tilt angle of about 2° to 3°, and 50-ms X-ray pulses were applied to the apparatus six times under the condition of a tube voltage of 80 kV and a tube current of 250 mA. The MTF chart was then removed, and X-ray pulses were applied to the apparatus six times under the same condition.

In the radiation imaging apparatus 1000, the humidity tolerance test in the environment of a temperature of 55° C. and a humidity of 95% decreased the MTF of the edge portion of the scintillator layer 105 by 30% as compared with that before the humidity tolerance test.

A temperature cycle test was performed for the radiation imaging apparatus 1000. The temperature cycle test was as follows. The radiation imaging apparatus 1000 was set on the evaluation apparatus. Processing in which the radiation imaging apparatus 1000 was left to stand for four hours in an environment of a temperature of 50° C. and a humidity of 60%, and was then left to stand for four hours in an environment of a temperature of −30° C. and a humidity of 0% was repeated five times. The sealing member 108 was visually evaluated for damage (crack or flaking off) due to a difference in thermal expansion between the scintillator panel 109 and the sensor panel 110. In the radiation imaging apparatus 1000, the sealing member 108 had not been damaged.

### Comparative Example 2

Similarly to the radiation imaging apparatus 1000, the radiation imaging apparatus was manufactured by adhering a scintillator panel 109 and a sensor panel 110, and forming a sealing member 108 by an epoxy-based resin, and the above-described humidity tolerance test and temperature cycle test were performed. In the humidity tolerance test, for the radiation imaging apparatus, in an environment of a temperature of 55° C. and a humidity of 95%, a decrease in MTF of the edge portion of a scintillator layer 105 was 5% or lower but the sealing member 108 was damaged in the temperature cycle test.

### Example 1

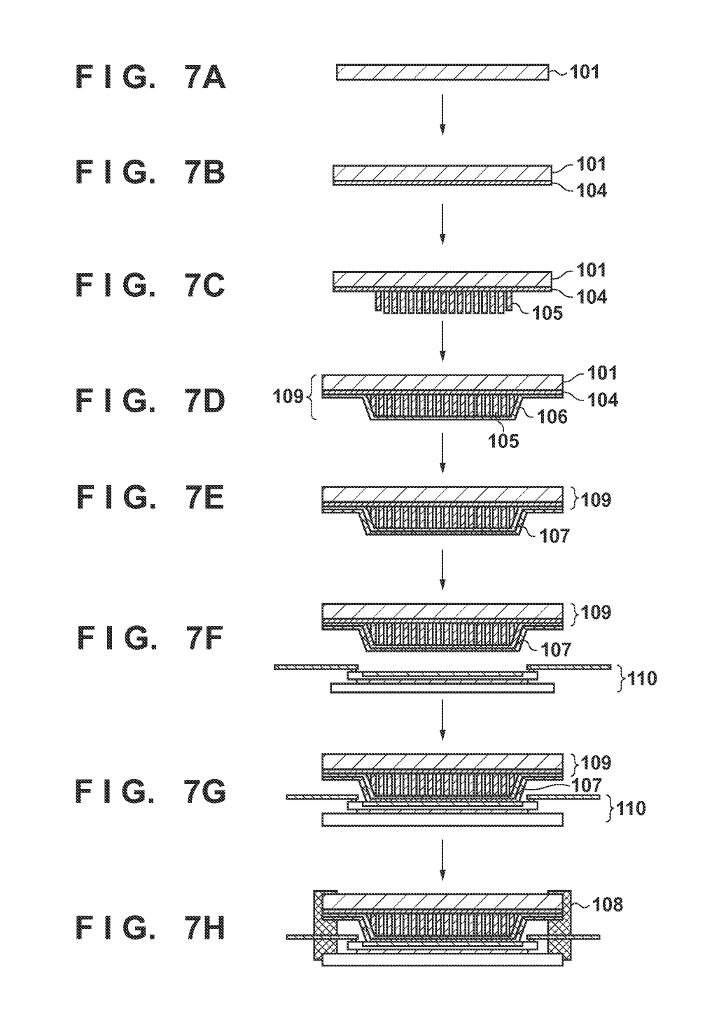

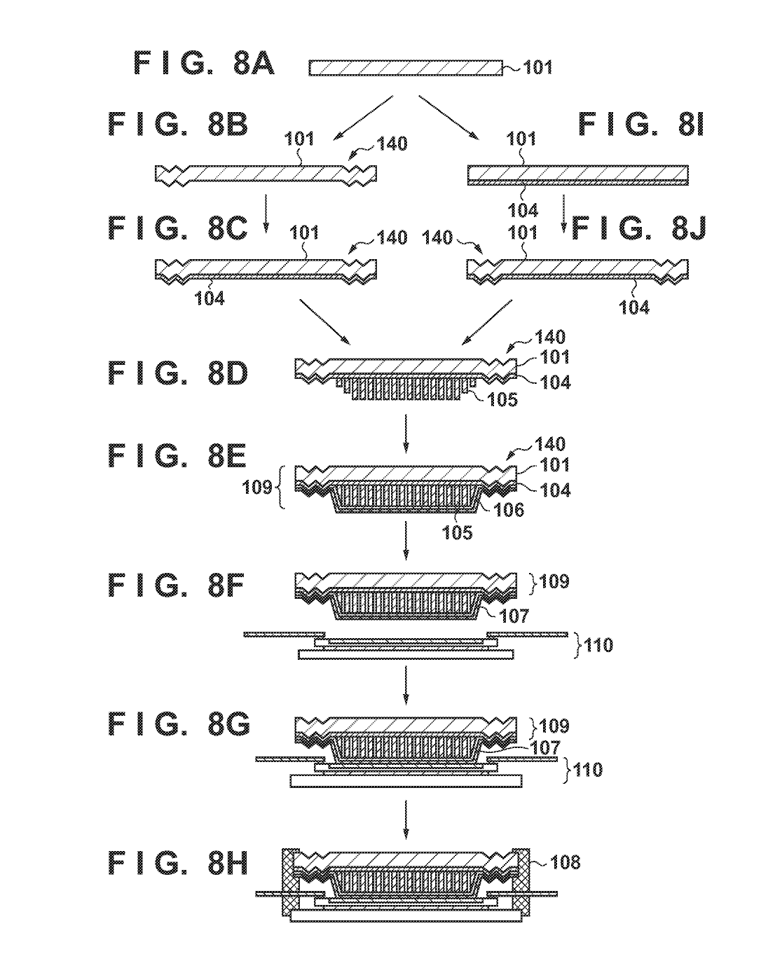

A method of manufacturing a radiation imaging apparatus 1 according to this embodiment will be described with reference to FIGS. 8A to 8J. A case in which a zigzag shape is formed as a bent portion 140 in a scintillator base 101 will be exemplified.

First, as shown in FIG. 8A, a scintillator base 101 made of aluminum is prepared. As shown in FIG. 8B, a zigzag-shaped bent portion 140 is formed in the scintillator base 101 by a press using a die. Next, as shown in FIG. 8C, a polyimide resin is applied to the scintillator base 101 in which a bent portion 140 is formed, and is cured, thereby forming a base protection layer 104. Note that as shown in FIGS. 8I and 8J, after forming a base protection layer 104 by applying a polyimide resin to the scintillator base 101 and curing the polyimide resin, the bent portion 140 may be formed by a press using a die.

Next, as shown in FIG. 8D, a scintillator layer 105 having a columnar crystal structure is formed on the base protection layer 104 formed on the scintillator base 101. A scintillator protection layer 106 made of polyethylene terephthalate (PET) is formed on the scintillator layer 105 by thermocompression bonding so as to cover the scintillator layer 105, as shown in FIG. 8E.

With the processes shown in FIGS. 8A to 8E or FIGS. 8A, 8I, 8J, 8D, and 8E, a scintillator panel 109 including the scintillator layer 105 for converting radiation into light with a wavelength detectable by photoelectric conversion elements is formed.

As shown in FIGS. 8F and 8G, the scintillator panel 109 is adhered to a sensor panel 110 via an adhesion layer 107 made of an acrylic-based resin. As shown in FIG. 8H, a sealing member 108 made of an epoxy-based resin having a high elastic modulus and high humidity resistance is formed in the edge portion of the scintillator base 101 and that of the sensor base 102, and external wiring lines 103 undergo thermocompression bonding to wiring leads 115 on a sensor substrate 112.

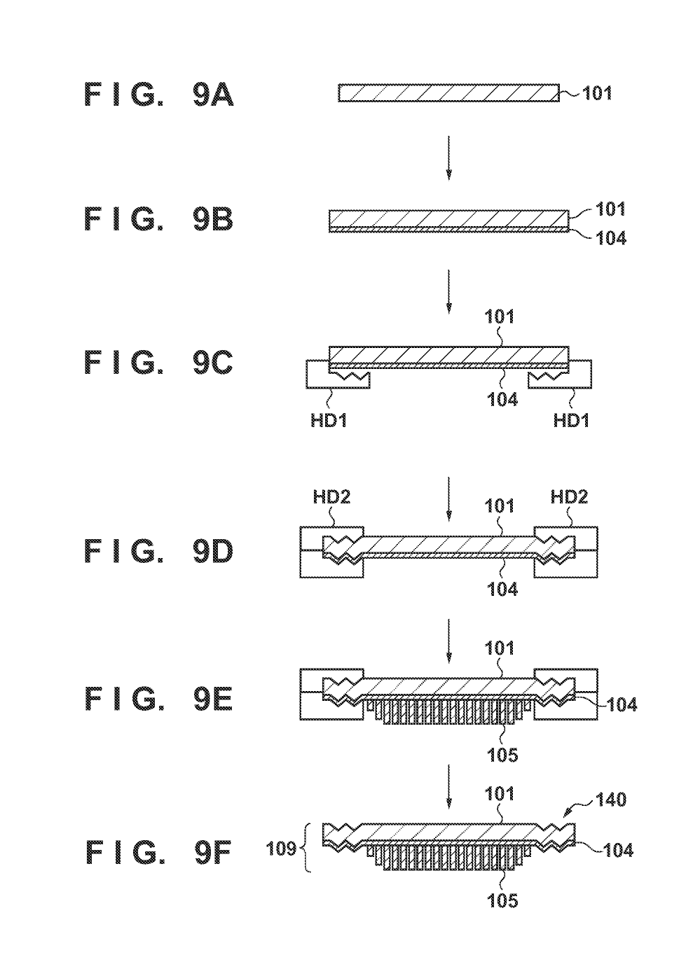

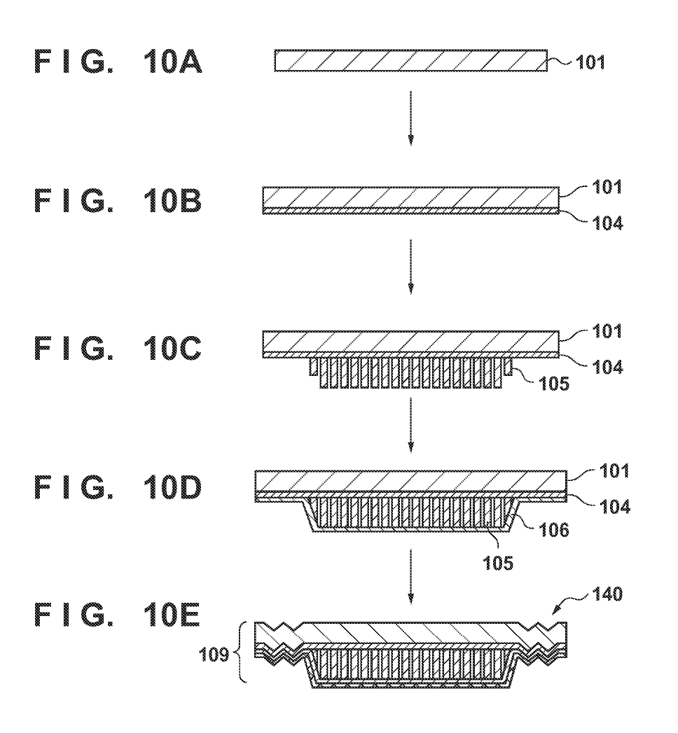

Furthermore, as shown in FIGS. 9A to 9F, a bent portion 140 may be formed by a press using holders HD1 and HD2 which fix the scintillator base 101 when depositing the scintillator layer 105. First, as shown in FIGS. 9A and 9B, a scintillator base 101 made of aluminum is prepared, and a base protection layer 104 is formed on the scintillator base 101. As shown in FIGS. 9C and 9D, the holder HD1 is used to support the scintillator base 101 on which the base protection layer 104 is formed, and the scintillator base 101 supported by the holder HD1 is sandwiched and fixed between the holders HD1 and HD2. Since an uneven surface corresponding to the shape of a bent portion 140 is formed on each of the holders HD1 and HD2, a bent portion 140 is formed in the scintillator base 101 by a press using the holders HD1 and HD2. As shown in FIG. 9E, in a state in which the holders HD1 and HD2 fix the scintillator base 101, a scintillator layer 105 having a columnar crystal structure is formed on the base protection layer 104. Next, as shown in FIG. 9F, the holders HD1 and HD2 are detached from the scintillator base 101.

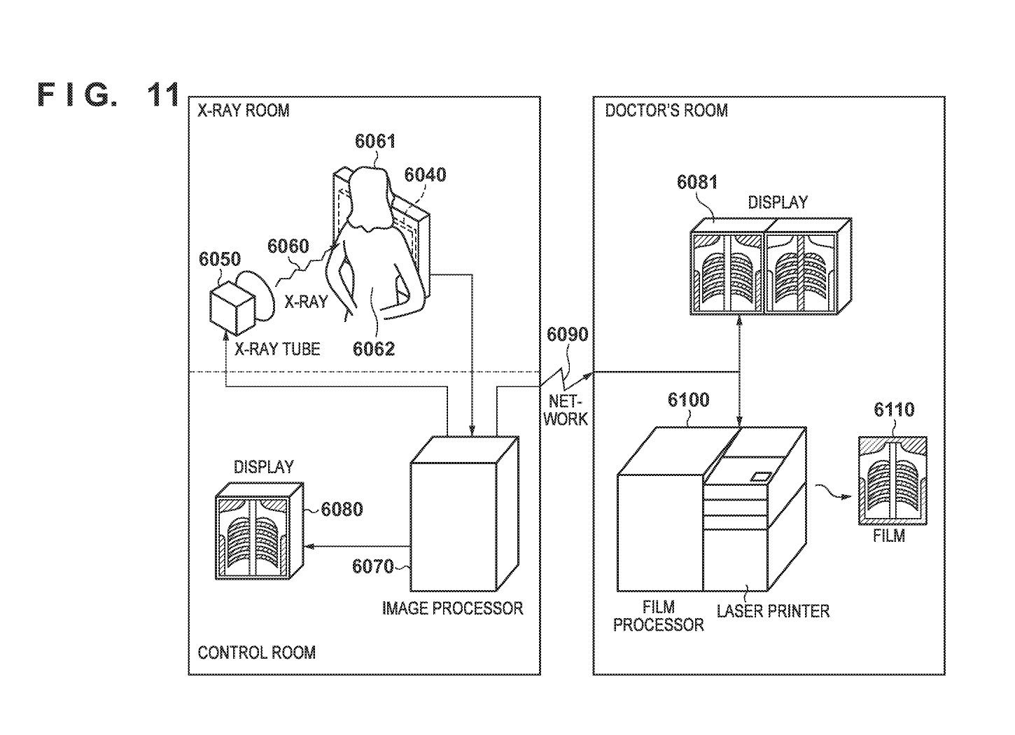

Moreover, as shown in FIGS. 10A to 10E, the bent portion 140 may be formed after forming the scintillator layer 105 and a scintillator protection layer 106. First, as shown in FIGS. 10A and 10B, a scintillator base 101 made of aluminum is prepared, and the base protection layer 104 is formed on the scintillator base 101. As shown in FIG. 10C, a scintillator layer 105 having a columnar crystal structure is formed on the base protection layer 104. As shown in FIG. 10D, a scintillator protection layer 106 made of polyethylene terephthalate (PET) is formed on the scintillator layer 105 by thermocompression bonding so as to cover the scintillator layer 105. After that, as shown in FIG. 10E, a zigzag-shaped bent portion 140 is formed in the scintillator base 101 by a press using a die.

The above-described humidity tolerance test was performed for the thus manufactured radiation imaging apparatus 1. In the humidity tolerance test, for the radiation imaging apparatus 1, in an environment of a temperature of 55° C. and a humidity of 95%, a decrease in MTF of the edge portion of the scintillator layer 105 was 5% or lower and the sealing member 108 was not damaged in the temperature cycle test.

### Example 2

A radiation imaging apparatus 1 (see FIG. 2) in which a concave portion 141 was formed as a bent portion 140 in a scintillator base 101 was manufactured by processes similar to those in Example 1, and the above-described humidity tolerance test and temperature cycle test were performed. In the humidity tolerance test, for the radiation imaging apparatus 1, in an environment of a temperature of 55° C. and a humidity of 95%, a decrease in MTF of the edge portion of a scintillator layer 105 was 5% or lower and a sealing member 108 was not damaged in the temperature cycle test.

### Example 3

A radiation imaging apparatus 1 (see FIG. 3B) in which a curved surface shape was formed as a bent portion 140 in a scintillator base 101 was manufactured by processes similar to those in Example 1, and the above-described humidity tolerance test and temperature cycle test were performed. In the humidity tolerance test, for the radiation imaging apparatus 1, in an environment of a temperature of 55° C. and a humidity of 95%, a decrease in MTF of the edge portion of a scintillator layer 105 was 5% or lower and a sealing member 108 was not damaged in the temperature cycle test.

### Example 4

A radiation imaging apparatus 1 (see FIG. 4B) in which a curved surface shape was formed as a bent portion 140 in a scintillator base 101 was manufactured by processes similar to those in Example 1, and the above-described humidity tolerance test and temperature cycle test were performed. Note that a convex portion 143 was formed by welding, to the scintillator base 101, a frame body made of the same material (aluminum) as that of the scintillator base 101. In the humidity tolerance test, for the radiation imaging apparatus 1, in an environment of a temperature of 55° C. and a humidity of 95%, a decrease in MTF of the edge portion of a scintillator layer 105 was 5% or lower and a sealing member 108 was not damaged in the temperature cycle test.

As described above, according to this embodiment, it is possible to realize the radiation imaging apparatus 1 in which the moisture resistance of the scintillator layer 105 and the strength of the sealing member 108 are high.

<Application>

The radiation imaging apparatus according to each of the above-described embodiments is applicable to a radiation imaging system. The radiation imaging system includes, for example, the radiation imaging apparatus (radiation detection apparatus), a signal processing unit including an image processor, a display unit including a display, and a radiation source for generating radiation. For example, as shown in FIG. 11, X-rays 6060 generated by an X-ray tube 6050 are transmitted through a chest 6062 of a patient (subject) 6061 and enter a radiation detection apparatus 6040. The incident X-rays bear information concerning the in-vivo information of the patient 6061. The scintillator emits light in accordance with the incident X-rays. A sensor panel detects this light to obtain the electrical information. After that, this information can be digitally converted, undergo image processing by an image processor 6070 (signal processing unit), and then be displayed on a display 6080 (display unit) in a control room. A transmission processing unit including a network 6090 such as a telephone, a LAN, or the Internet can also transfer this information to a remote place. This makes it possible to display the information on a display 6081 in a doctor room or the like in another place and allow a doctor in a remote place to make diagnosis. In addition, the information can be stored in, for example, an optical disk. Alternatively, a film processor 6100 can record the information on a recording unit such as a film 6110.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-220716 filed on Oct. 2, 2012, which is hereby incorporated by reference herein in its entirety.

What is claimed is:

1. A radiation imaging apparatus comprising:
a sensor substrate on which photoelectric conversion elements are arranged;
a scintillator base on which a scintillator layer for converting radiation into light with a wavelength detectable by the photoelectric conversion elements is arranged, and which is adhered to the sensor substrate so that the scintillator layer is arranged between the sensor substrate and the scintillator base; and
a sealing member configured to fix an edge portion of the scintillator base and the sensor substrate, and spaced apart from the scintillator layer,
wherein the scintillator base includes a bent portion for reducing a stress that acts on the sealing member in a region between an outer edge of a region in which the scintillator layer is arranged and the edge portion fixed by the sealing member.

2. The apparatus according to claim 1, wherein the bent portion has a zigzag shape in a cross section perpendicular to a surface of the scintillator base.

3. The apparatus according to claim 1, wherein the bent portion includes a concave portion concave toward the sensor substrate in a cross section perpendicular to a surface of the scintillator base.

4. The apparatus according to claim 1, wherein the bent portion has a curved surface shape curving toward the sensor substrate in a cross section perpendicular to a surface of the scintillator base.

5. The apparatus according to claim 1, wherein the bent portion includes a convex portion convex toward the sensor substrate in a cross section perpendicular to a surface of the scintillator base.

6. The apparatus according to claim 4, further comprising
a wiring lead configured to connect the sensor substrate to an external flexible substrate and arranged in the sensor substrate,
wherein the bent portion includes a supporting portion for supporting the flexible substrate.

7. The apparatus according to claim 1, wherein
l₁−l₂≧(α−β)×L×(t₁−t₂)
where l₁ represents a distance, along a surface of the scintillator base, from the outer edge of the region in which the scintillator layer is arranged to the edge portion fixed by the sealing member, and l₂ represents a linear distance from the outer edge of the region in which the scintillator layer is arranged to the edge portion fixed by the sealing member, L represents a longest distance from a center of the scintillator base to the edge portion, α represents a thermal expansion coefficient of the scintillator base, β represents a thermal expansion coefficient of the sensor substrate, t₁ represents a curing temperature of the sealing member, and t₂ represents a lowest temperature in an environment in which the radiation imaging apparatus is used.

8. The apparatus according to claim 1, wherein the scintillator layer has an area smaller than that of the scintillator base.

9. The apparatus according to claim 1, wherein the scintillator layer contains cesium iodide as a principal component.

10. The apparatus according to claim 1, further comprising
a sensor base to which the sensor substrate is adhered,
wherein the sealing member fixes the edge portion of the scintillator base and the sensor substrate by fixing the edge portion of the scintillator base and the sensor base.

11. The apparatus according to claim 1, wherein the sealing member has an elastic modulus not lower than 1 GPa.

12. The apparatus according to claim 1, wherein the scintillator base is made of at least one of aluminum, magnesium, and an alloy containing aluminum or magnesium as a principal component.

13. The apparatus according to claim 1, wherein the sealing member is made of a thermosetting resin.

14. A radiation imaging system comprising:
a radiation imaging apparatus according to claim 1;
a signal processing unit configured to process a signal from the radiation imaging apparatus; and
a display unit configured to display a signal from the signal processing unit.

15. A method of manufacturing a radiation imaging apparatus comprising a sensor substrate on which photoelectric conversion elements are arranged, a scintillator base on which a scintillator layer for converting radiation into light with a wavelength detectable by the photoelectric conversion elements is arranged and which is adhered to the sensor substrate so that the scintillator layer is arranged between the sensor substrate and the scintillator base, and a sealing member configured to fix an edge portion of the scintillator base and the sensor substrate and spaced apart from the scintillator layer, the method comprising:
a step of forming a bent portion for reducing a stress that acts on the sealing member in a region between an outer edge of a region of the scintillator base in which the scintillator layer is arranged and the edge portion fixed by the sealing member.

16. The method according to claim 15, wherein in the step, the bent portion is formed by a press using a holder for fixing the scintillator base when depositing the scintillator layer, and
an uneven surface corresponding to a shape of the bent portion is formed on the holder.

17. The method according to claim 15, wherein in the step, the bent portion is formed by a press using a die on which an uneven surface corresponding to a shape of the bent portion is formed.

18. The method according to claim 15, wherein in the step, the bent portion is formed by laser processing.
